(19) United States
(12) Patent Application Publication
(10) Pub. No.: US 2007/0213057 A1
(43) Pub. Date: Sep. 13, 2007

(54) METHOD AND APPARATUS FOR SUPPORTING ROUTING AREA UPDATE PROCEDURES IN A SINGLE TUNNEL GPRS-BASED WIRELESS COMMUNICATION SYSTEM

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/626,451

(22) Filed: Jan. 24, 2007

Related U.S. Application Data
(60) Provisional application No. 60/780,235, filed on Mar. 8, 2006.

(51) Int. Cl. H04Q 7/20

(52) U.S. Cl. 455/436

(57) ABSTRACT

A method and apparatus for supporting routing area update procedures in a single tunnel general packet radio services (GPRS)-based wireless communication system are disclosed. A wireless transmit/receive unit (WTRU) sends a routing area update request message to a serving general packet radio service (GPRS) support node (SGSN) via a radio network controller (RNC). The SGSN sends an update packet data protocol (PDP) context request message to a gateway GPRS support node (GGSN). The GGSN sends an update PDP context response message to the SGSN. The SGSN sends a tunnel establishment request message to the RNC and a single tunnel is established between the RNC and the GGSN. For handover operations, a previous single tunnel established between the GGSN and another RNC is released and the routing area update is accepted and completed.

### CROSS REFERENCE TO RELATED APPLICATIONS

This application claims the benefit of U.S. Provisional Application No. 60/780,235 filed Mar. 8, 2006, which is incorporated by reference as if fully set forth.

### FIELD OF INVENTION

The present invention is related to a wireless communication system. More particularly, the present invention is related to a method and apparatus for supporting routing area update in a single tunnel general packet radio service (GPRS)-based wireless communication system.

### BACKGROUND

FIG. 1 shows a conventional GPRS/third generation (3G) wireless communication system architecture 100 that shows various interfaces/protocols as well as user data transfer interfaces between various network entities. The wireless communication system 100 includes at least one serving GPRS support node (SGSN) 105 and at least one gateway GPRS support node (GGSN) 110. The wireless communication system 100 further comprises a universal terrestrial radio access network (UTRAN) 115 which includes one or more radio access networks (RANs), base station systems (BSSs) and radio network controllers (RNCs), (not shown). The system 100 also comprises a plurality of wireless transmit/receive units (WTRUs) 120, each including a terminal equipment (TE) 125 coupled to a mobile terminal (MT) 130. The mobility in the wireless communication system 100 is facilitated by anchoring an Internet Protocol (IP) session at the GGSN 110 and allowing for multi-level mobility by supporting mobility management (MM) protocols for IP and non-IP traffic/services provided by the SGSN 105.

FIG. 2A shows how dual tunnels are established in the conventional wireless communication system 100 of FIG. 1 to provide IP connectivity for user plane traffic. As shown in FIG. 2A, a GPRS tunnelling protocol (GTP) user plane (GTP-U) tunnel 220 is established between a GGSN 205 and an SGSN 210, and a second user plane tunnel 225 is established between the SGSN 210 and a radio network controller (RNC) 215. Both tunnels are dedicated to the same user. The GTP tunnel 220 has a user plane and a control plane. The user tunnel 225 is an IP tunnel having a user plane and a RAN application part (RANAP) control plane used for control messaging.

A routing area update (RAU) is used to minimize the paging traffic within a wireless communication system that is grouped into clusters. Each cluster includes a group of cells (Node-Bs). Each cluster is defined by a unique identifier, (i.e., routing area identifier (ID)). Those WTRUs in the wireless communication system that travel across boundaries of the clusters have to perform a registration process called a routing area update. In the RAU, the WTRU informs the core network regarding which area of the system it is operating in. If the WTRU receives a terminated call, the core network pages the WTRU in the last known routing area. This eliminates the need to send a paging message for the WTRU throughout the entire system, which in turn significantly reduces the amount of signalling across the system. Thus, more processing power is allocated to user traffic. The RAU may require the establishment of a new connection between a GGSN and a new RNC. New processes and message formats are needed for a single tunnel approach as compared to those existing in a two tunnel approach.

In the evolution toward an all IP Network (AIPN), most of the services and applications are migrating toward IP based platforms. This migration requires IP connectivity, and the generated traffic does not have to be terminated at the SGSN. Therefore, a single tunnel functionality is desirable to reduce the delay and processing power at the SGSN.

### SUMMARY

The present invention is related to a method and apparatus for supporting routing area update using a single tunnel in a GPRS/3G network and beyond. A wireless transmit/receive unit (WTRU) sends an activate packet data protocol (PDP) context request to an SGSN via an RNC, and the SGSN sends a create PDP context request to a GGSN. The create PDP context request includes a PDP type, a PDP address, an access point name (APN), a single tunnel request, an RNC tunnel endpoint identity (TEID) and quality of service (QoS) data, whereby a single tunnel is established between the GGSN and the RNC.

In one embodiment, a WTRU sends a routing area update request message to an SGSN via an RNC. The SGSN sends an update PDP context request message to a GGSN. The GGSN sends an update PDP context response message to the SGSN. The SGSN sends a tunnel establishment request message to the RNC, and a single tunnel is established between the RNC and the GGSN. For handover operations, a previous single tunnel established between the GGSN and another RNC is released and the routing area update is accepted and completed.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional GPRS and 3G wireless communication system;

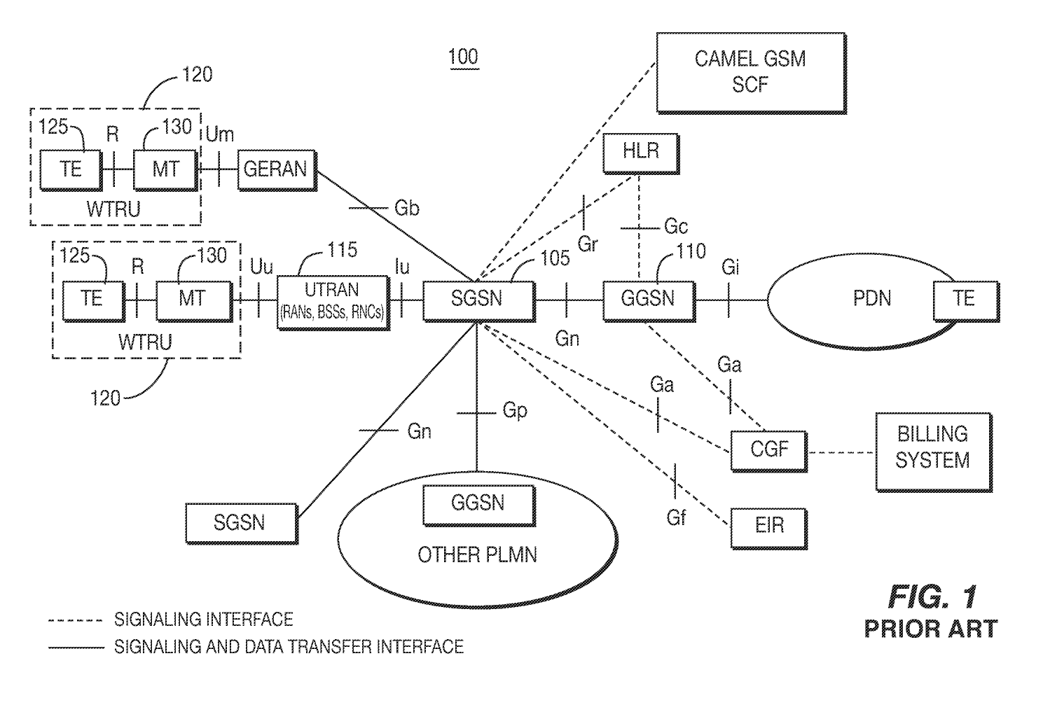

FIG. 2A shows the conventional establishment of dual tunnels;

FIG. 2B shows the establishment of a single tunnel in accordance with the present invention;

FIG. 3 shows a prior art tunnel protocol stack;

FIG. 4 shows a single tunnel protocol stack configured in accordance with the present invention;

FIG. 5 shows a single tunnel establishment procedure, (PDP context activation), which is implemented in accordance with the present invention;

FIG. 6 shows a single tunnel intra-SGSN inter-RNC routing area update procedure in accordance with one embodiment of the present invention; and

FIGS. 7A and 7B, taken together, show a single tunnel intre-SGSN routing area update procedure in accordance with another embodiment of the present invention.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The features of the present invention may be incorporated into an integrated circuit (IC) or be configured in a circuit comprising a multitude of interconnecting components.

In accordance with the present invention, the mobility in GPRS, (3G or beyond), systems is facilitated by anchoring the IP session at the home GGSN and allowing for multi-level mobility, and by supporting existing MM protocols for non-IP traffic/services provided by the SGSN.

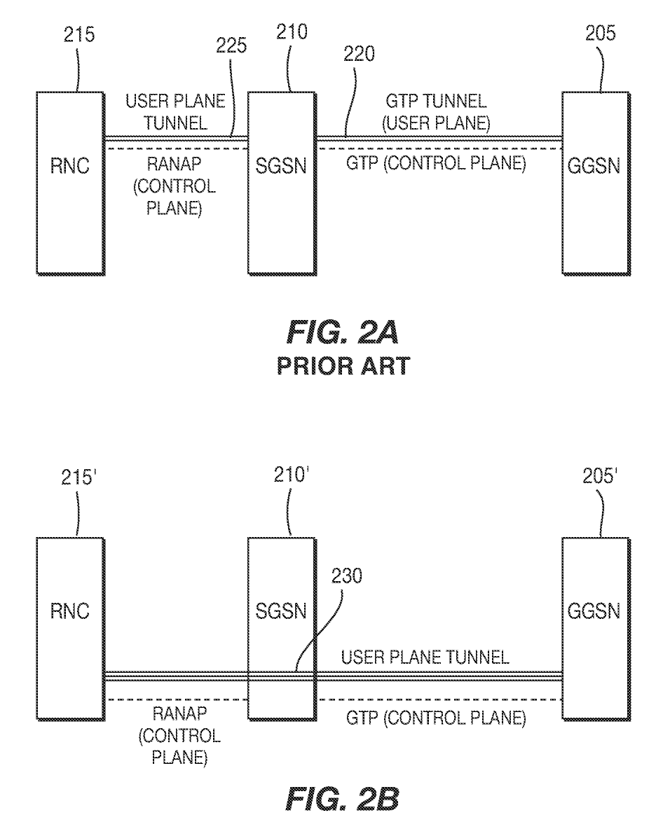

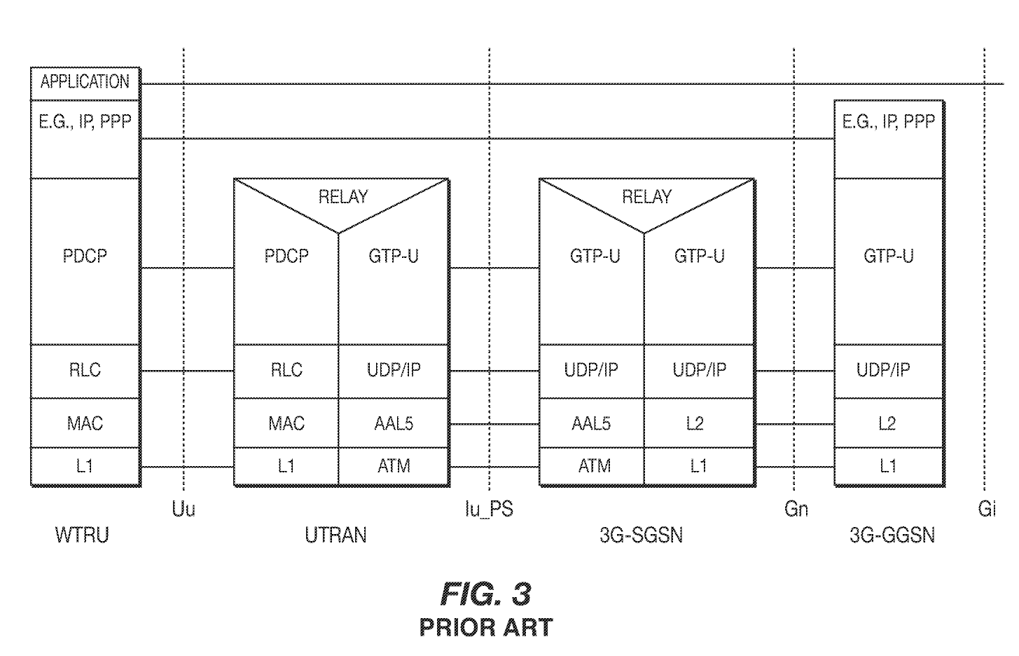

FIG. 2B shows a single user-plane tunnel approach in accordance with the present invention. A single user plane tunnel 230 is used to reduce the delay and processing power of an SGSN 210′. In the two-tunnel approach shown in FIG. 2A, the SGSN 210 terminates both the GTP tunnel 220 and a user plane tunnel 225 to the RNC 215, which means that the SGSN 210 decodes the packets traveling in both directions and translates them into the different protocol formats of the two tunnels 220 and 225. In a single tunnel approach shown in FIG. 2B, the SGSN 210′ only establishes a tunnel between the GGSN 205′ and the RNC 215′ via two separate interfaces/protocols, (RANAP-C and GTP-C). In the single tunnel approach, the SGSN 210′ is no longer involved in the user plane traffic. Thus, the user traffic passes through the SGSN 210′ unchanged, (i.e., unaltered), in both directions. The SGSN 210′ is no longer involved in the user plane processing. Only the RNC 215′ and the GGSN 205′ are allowed to perform/act on the user plane traffic. The SGSN 210′ only manages the control traffic, including MM, RAU, and the like, associated with the user and its IP based traffic. The SGSN 210′ connects an RNC 215′ and a GGSN 205′ using a GTP control plane to communicate with the GGSN 205′ and a RANAP control plane to communicate with the RNC 215′. When a handoff occurs between RNCs, the SGSN 210′ is responsible for providing the GGSN 205′ with the new RNC TEID information and the establishment of the single tunnel 230.

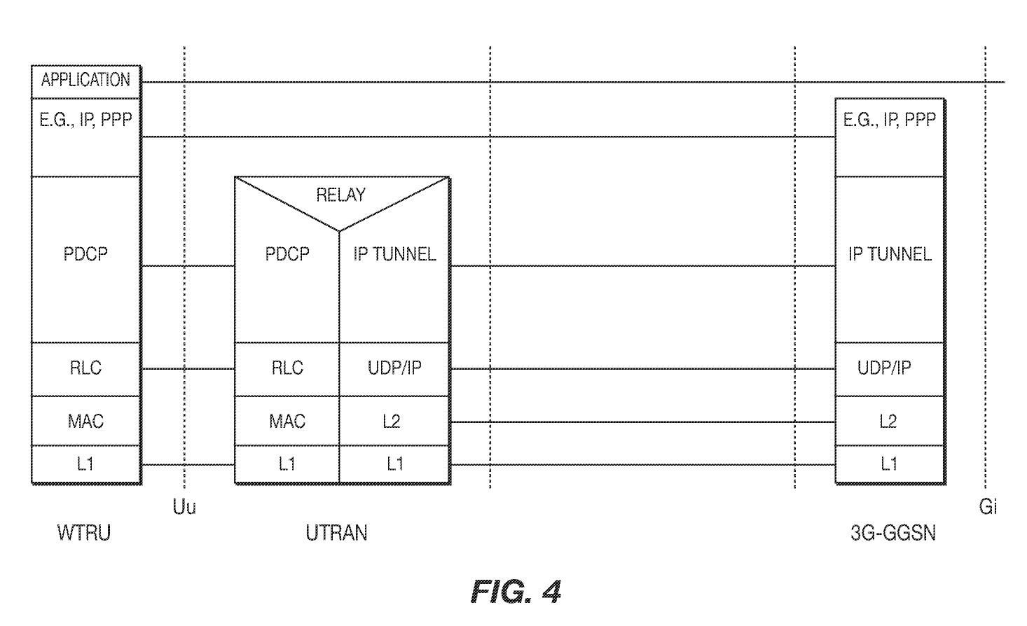

FIG. 3 shows a prior art tunnel protocol stack according to existing GPRS protocol. A GTP-U tunnel transfers, (i.e., tunnels), user data between a UTRAN (which includes RANs, BSSs and RNCs) and a 3G-SGSN, and between the 3G-SGSN and a 3G-GGSN.

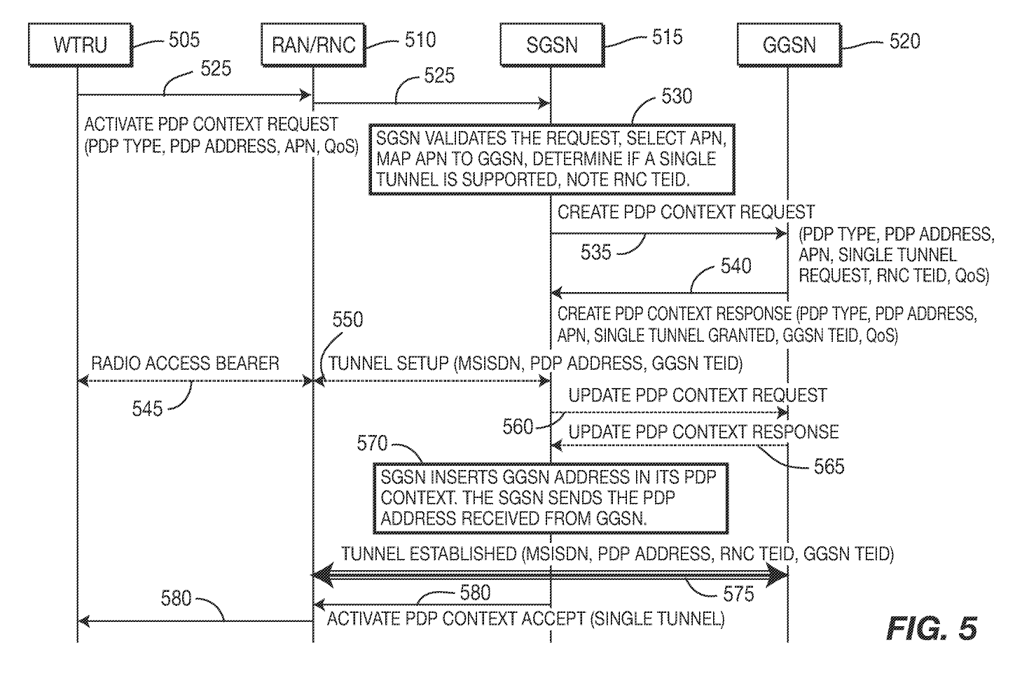

FIG. 4 shows a user plane in the single tunnel protocol stack in accordance with the present invention, in which the user plane tunnel from the UTRAN does not terminate at the 3G-SGSN. Instead, the UTRAN terminates at the 3G-GGSN. The IP Tunnel shown in UTRAN and GGSN can be GTP based or any generic IP-Tunnel. In a preferred embodiment, the GTP-U tunnel is used as an IP tunnel.

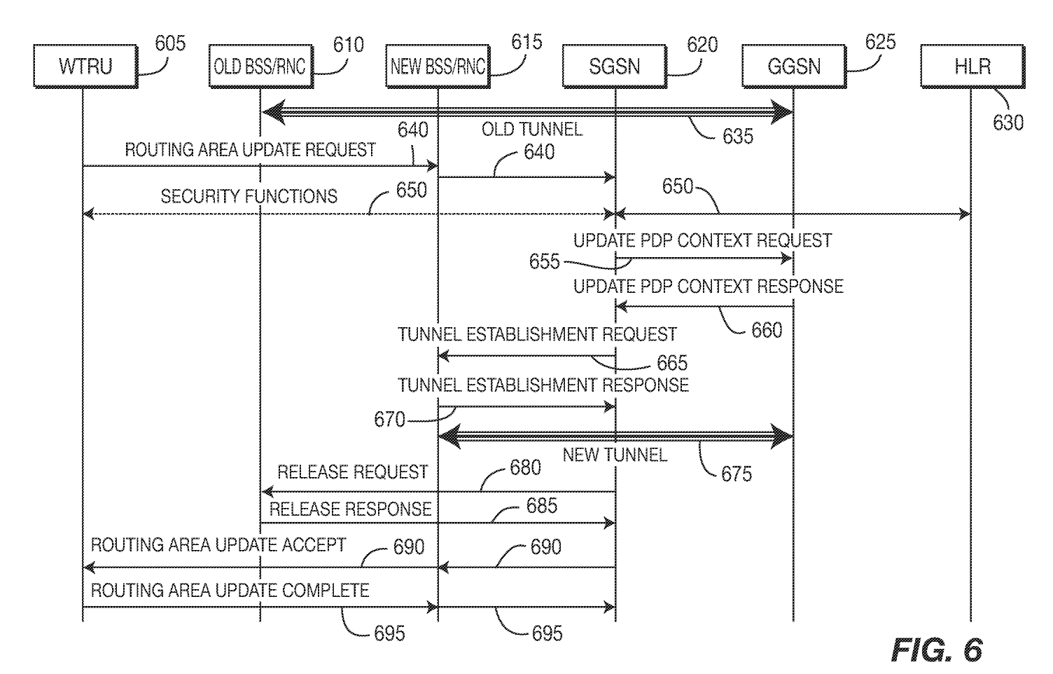

FIG. 5 is a signaling diagram of a process for single tunnel establishment in accordance with the present invention. The single tunnel functionality reduces the delay and processing power at the SGSN by reducing the need for protocol translation between the RNC and GGSN interfaces, and by enabling direct user plane tunnel between the RAN/RNC and the GGSN within the packet switched (PS) domain. However, the single tunnel approach will not eliminate the need for the SGSN to manage control traffic for IP based traffic. The SGSN is still needed for the control plane signalling, MM and call/session management, and makes a decision when to establish a single tunnel rather than establishing dual tunnels.

In the case of a single tunnel, the SGSN should connect the RAN/RNC TEID and the GGSN TEID for user plane by informing each end point of the tunnel of the corresponding TEID of the other end point, (i.e., informing the GGSN of the RNC TEID and informing the RNC of the GGSN TEID). In the case of a handoff between RNCs, the SGSN is responsible for updating and providing the GGSN with new RNC TEID information and the establishment of the single tunnel.

FIG. 5 shows a single tunnel establishment procedure, (packet data protocol (PDP) context activation), which is implemented in a wireless communication system including a WTRU 505, a radio access network (RAN)/radio network controller (RNC) 510, an SGSN 515 and a GGSN 520 in accordance with the present invention. The WTRU 505 sends an activate PDP context request to the SGSN 515 that includes PDP type, PDP address, APN, quality of service (QoS) data and the like), (step 525). The SGSN 515 validates the activate PDP context request, selects an APN), and maps the APN to the GGSN 520 (step 530). The SGSN 515 determines if a single tunnel is supported and/or requested, and notes the existence of an RNC TEID (step 530). The SGSN 515 creates a PDP context request that includes PDP Type, PDP Address, APN, a single tunnel request, an RNC TEID, QoS and the like), (step 535). The GGSN 520 creates a PDP context response that includes PDP Type, PDP Address, APN, an indicator that the single tunnel is granted, GGSN TEID, QoS and the like (step 540). The WTRU 505 and the RAN/RNC 510 establish a radio access bearer (RAB) (step 545). In step 550, the SGSN 515 and the RAN/RNC 510 exchange tunnel setup signaling that includes a mobile station international subscriber directory number (MSISDN), a PDP address and a GGSN TEID, and the SGSN 515 sends tunnel establishment information to the RAN/RNC 510 after receiving an indication of acceptance from the GGSN to establish the tunnel. The SGSN 515 sends an update PDP context request to the GGSN 520 (step 560) to establish the new tunnel by informing the GGSN 520 of the RNC TEID associated with the request, and the GGSN 520 sends an update PDP context response to the SGSN 515 (step 565) confirming/rejecting the establishment of the tunnel and the associated attributes, (RNC TEID, PDP type, PDP address, user ID, and the like). The SGSN 515 inserts the GGSN address in its PDP context, sends the PDP address received from the GGSN (step 570) and prepares for the response to be sent down to the WTRU 505. Thus, if necessary, the SGSN 515 updates the PDP context in the GGSN 520 to reflect any changes in the QoS attributes resulting from the RAB establishment of step 545. Tunnel establishing signaling is exchanged between the RAN/RNC 510 and the GGSN 520 including the MSISDN, PDP address, RNC TEID and GGSN TEID (step 575). The SGSN 515 sends an activate PDP context accept signal to the WTRU 505 that indicates the presence of a single tunnel (step 580).

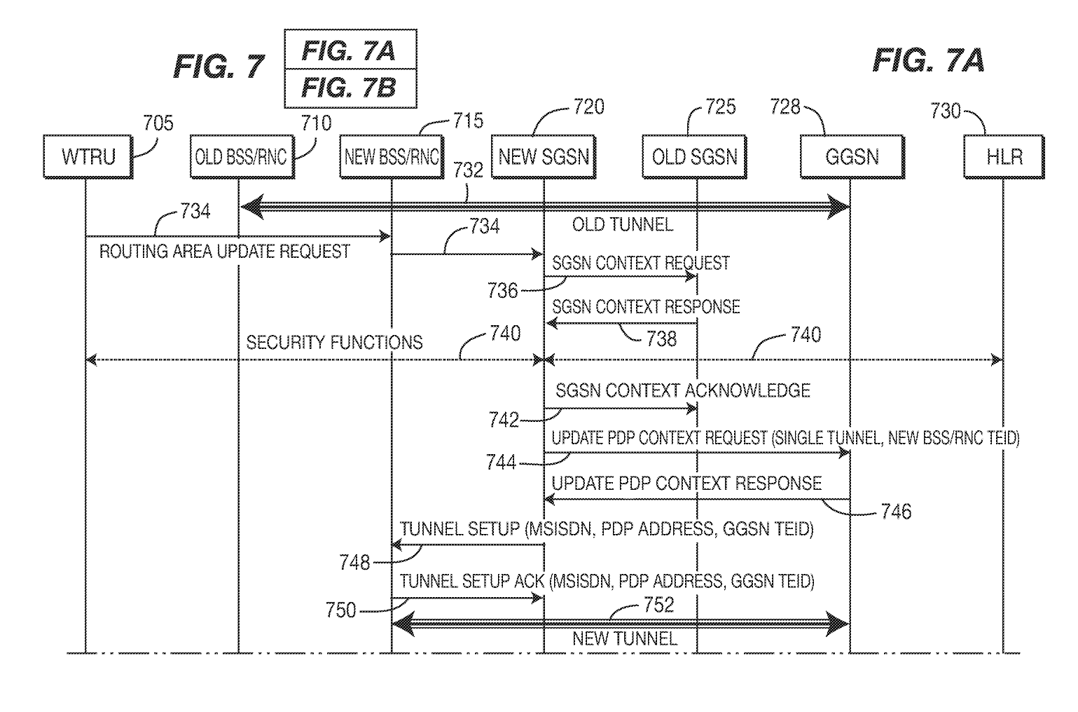

FIG. 6 shows a single tunnel intra-SGSN inter-RNC routing area update procedure, which is implemented in a wireless communication system including a WTRU 605, an old base station system (BSS)/RNC 610, a new BSS/RNC 615, an SGSN 620, a GGSN 625 and a home location register (HLR) 630 in accordance with the present invention.

Still referring to FIG. 6, an old tunnel is established between the old BSS/RNC 610 and the GGSN 625 (step 635). The WTRU 605 sends a routing area update (RAU) request, which may include a packet temporary mobile subscriber identity (P-TMSI), old routing area identification (RAI), old P-TMSI signature, an update type and the like, to the new BSS/RNC 610 and the SGSN 620 (step 640). The update type indicates whether or not the routing area update is periodic. Security functions are then established between the WTRU 605, the SGSN 620 and the HLR 630 (step 650). The SGSN 620 sends an update PDP context request to the GGSN 625 (step 655). The GGSN 625 then sends an update PDP context response to the SGSN 620 (step 660). The SGSN 620 sends a tunnel establishment request to the new BSS/RNC 615 (step 665). In step 655, the SGSN 620 establishes the new tunnel between the GGSN 625 and the new BSS/RNC 615 by sending the TEID of the new BSS/RNC 615 to the GGSN 625 in the update PDP context request of step 660. If the request is granted, the GGSN 625 confirms the request back to the SGSN 620 in step 660. In step 665, the SGSN 620 establishes the other end of the tunnel to the new BSS/RNC 615 by sending the TEID of the GGSN 625 to the new BSS/RNC 615 via the tunnel establishment message. In step 670, the BSS/RNC 615 acknowledges the request and indicates the operation success to the SGSN 620. Now, a new tunnel is established in step 675. Optionally, there may be additional update PDP context requests depending on the final set of QoS attributes. The new BSS/RNC 615 then sends a tunnel establishment response to the SGSN 620 (step 670). A new tunnel between the new BSS/RNC 615 and the GGSN 625 is then established (step 675). Upon the successful establishment of the new tunnel, the SGSN 620 releases the old tunnel by sending a release request to the old BSS/RNC 610 in step 680. A release response is sent from the old BSS/RNC 610 to the SGSN 620 (step 685). A routing area update accept is sent from the SGSN 620 to the new BSS/RNC 615 and the WTRU 605 (step 690). A routing area update complete message is then sent from the WTRU 605 to the new BSS/RNC 615 and the SGSN 620 (step 695).

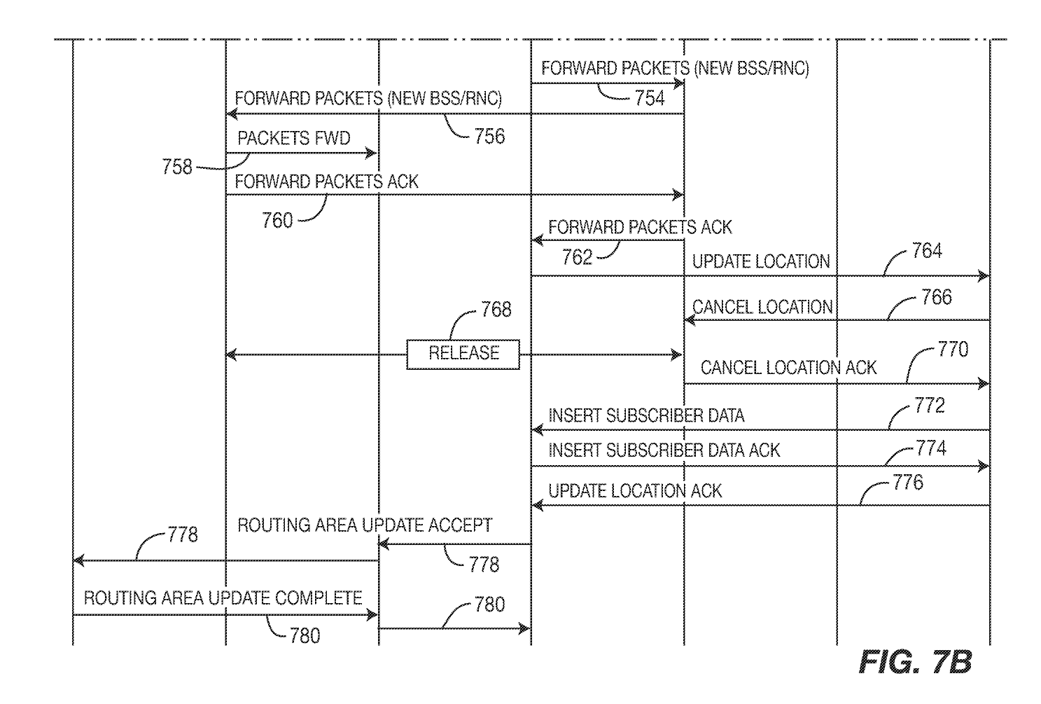

FIGS. 7A and 7B, taken together, show a single tunnel intre-SGSN routing area update procedure, which is implemented in a wireless communication system including a WTRU 705, an old BSS/RNC 710, a new BSS/RNC 715, a new SGSN 720, an old SGSN 725, a GGSN 728 and an HLR 730 in accordance with the present invention.

Referring to FIG. 7A, an old tunnel is established between the old BSS/RNC 710 and the GGSN 728 (step 732). The WTRU 705 sends a routing area update request, which may include a P-TMSI, old RAI, old P-TMSI signature, an update type and the like, to the new BSS/RNC 734 and the new SGSN 720 (step 734). The update type indicates whether or not the routing area update is periodic. The new SGSN 720 sends an SGSN context request to the old SGSN 725 (step 736). The old SGSN 725 sends an SGSN context response to the new SGSN 720 (step 738). Security functions are then established between the WTRU 705, the new SGSN 720 and the HLR 730 (step 740). The new SGSN 620 sends an SGSN context acknowledge message to the old SGSN 725 (step 742) and sends an update PDP context request to the GGSN 728 (step 655) which indicates a single tunnel and the TEID of the new BSS/RNC 715. The GGSN 728 then sends an update PDP context response to the new SGSN 720 (step 746). The new SGSN 720 sends a tunnel setup message to the new BSS/RNC 715 which indicates the MSISDN, PDP address and the GGSN TEID (step 748). The new BSS/RNC 715 then sends a tunnel setup acknowledgement message to the new SGSN (step 750). A new tunnel between the new BSS/RNC 715 and the GGSN 728 is then established (step 752).

In the case of pending traffic in the system using the old tunnel, the traffic is forwarded from the old BSS/RNC 610 to the new BSS/RNC 615 for service continuity. Referring to FIG. 7B, after the new tunnel is established, forward packets are sent from the new SGSN 720 to the old SGSN 725 (step 754). In step 754, forward packets are sent from the new SGSN 720 to the old SGSN 725. In step 756, forward packets are sent from the old SGSN 725 to the old BSS/RNC 710. In step 758, packets are forwarded from the old BSS/RNC 710 to the new BSS/RNC 715. In step 760, the old BSS/RNC 710 sends a forward packets acknowledgement message to the old SGSN 725. In step 762, the old SGSN 725 sends a forward packets acknowledgement message to the new SGSN 720. In step 764, the new SGSN sends update location message to the HLR 730. In step 766, the HLR 730 sends a cancel location message to the old SGSN 725. In step 768, release signaling, (e.g., a release request message and a release response message), is exchanged between the old BSS/RNC 710 and the old SGSN 725. In step 770, a cancel location acknowledgement message is sent from the old SGSN 725 and the HLR 730. In step 772, insert subscriber data is sent from the HLR 730 to the new SGSN 720. In step 774, the new SGSN 720 sends an insert subscriber data acknowledgement message to the HLR 730. In step 776, the HLR 730 sends an update location acknowledgement message to the new SGSN 720. In step 778, the new SGSN 720 sends a routing area update accept message to the new BSS/RNC 715 and the WTRU 705. In step 780, the WTRU 705 sends a routing area update complete message to the new BSS/RNC and the new SGSN 720.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of establishing a single tunnel for a wireless transmit/receive unit (WTRU) in a wireless communication system including a radio network controller (RNC), a serving general packet radio service (GPRS) support node (SGSN) and a gateway GPRS support node (GGSN), the method comprising:
(a) the WTRU sending an activate packet data protocol (PDP) context request message to the SGSN via the RNC;
(b) the SGSN sending a create PDP context request message to the GGSN, the create PDP context request message including a single tunnel request, a PDP address and a tunnel endpoint identity (TEID) of the RNC; and
(c) establishing a single tunnel between the GGSN and the RNC.

2. The method of claim 1 further comprising:
the SGSN determining whether a single tunnel is supported, whereby the SGSN includes the single tunnel request in the create PDP context request message only if a single tunnel is supported.

3. The method of claim 1 wherein step (c) further comprises:
(c1) the GGSN sending a create PDP context response message to the SGSN in response to receiving the create PDP context request message, the create PDP context response message including a PDP address and a TEID of the GGSN;
(c2) the SGSN receives the create PDP context response message and exchanges tunnel setup information with the RNC; and
(c3) the SGSN inserting the address of the GGSN in its PDP context and sending the PDP address received from the GGSN to the RNC, whereby the single tunnel between the GGSN and the RNC is established.

4. A wireless communication system comprising:
a wireless transmit/receive unit (WTRU);
a radio network controller (RNC);
a serving general packet radio service (GPRS) support node (SGSN); and
a gateway GPRS support node (GGSN), wherein the WTRU is configured to send an activate packet data protocol (PDP) context request message to the SGSN via the RNC, the SGSN is configured to send a create PDP context request message to the GGSN, the create PDP context request message including a single tunnel request, a PDP address and a tunnel endpoint identity (TEID) of the RNC, and a single tunnel is established between the GGSN and the RNC.

5. The system of claim 4 wherein the SGSN determines whether a single tunnel is supported, whereby the SGSN includes the single tunnel request in the create PDP context request message only if a single tunnel is supported.

6. The system of claim 4 wherein the GGSN sends a create PDP context response message to the SGSN in response to receiving the create PDP context request message, the create PDP context response message including a PDP address and a TEID of the GGSN.

7. The system of claim 6 wherein the SGSN receives the create PDP context response message and exchanges tunnel setup information with the RNC, and the SGSN inserts the address of the GGSN in its PDP context and sends the PDP address received from the GGSN to the RNC, whereby the single tunnel between the GGSN and the RNC is established.

8. A method of performing a routing area update procedure for a wireless transmit/receive unit (WTRU) in a wireless communication system including a first radio network controller (RNC), a second RNC, a serving general packet radio service (GPRS) support node (SGSN) and a gateway GPRS support node (GGSN), wherein a first tunnel is established between the first RNC and the GGSN, the method comprising:
the WTRU sending a routing area update request message to the second RNC and the SGSN;
the SGSN sending an update packet data protocol (PDP) context request message to the GGSN;
the GGSN sending an update PDP context response message to the SGSN;
the SGSN sending a tunnel establishment request message to the second RNC;
the second RNC sending a tunnel establishment response message to the SGSN; and
establishing a second tunnel between the second RNC and the GGSN.

9. The method of claim 8 further comprising:
the SGSN sending a release request to the first RNC;
the first RNC sending a release response to the SGSN;
the SGSN sending a routing area update accept message to the WTRU; and
the WTRU sending a routing area update complete message to the SGSN.

10. A method of performing a routing area update procedure for a wireless transmit/receive unit (WTRU) in a wireless communication system including a first radio network controller (RNC), a second RNC, a first serving general packet radio service (GPRS) support node (SGSN), a second SGSN and a gateway GPRS support node (GGSN), wherein a first tunnel is established between the first RNC and the GGSN, the method comprising:
the WTRU sending a routing area update request to the second RNC and the first SGSN;
the first SGSN sending an SGSN context request message to the second SGSN;
the second SGSN sending an SGSN context response message to the first SGSN;
the first SGSN sending an update packet data protocol (PDP) context request to the GGSN;
the GGSN sending an update PDP context response to the first SGSN;
the first SGSN sending a tunnel setup message to the second RNC;
the second RNC sending a tunnel setup acknowledgement message to the first SGSN; and
establishing a second tunnel between the second RNC and the GGSN.
